(19) United States
(12) Patent Application Publication
(10) Pub. No.: US 2003/0206652 A1
(43) Pub. Date: Nov. 6, 2003

(54) Depth map creation through hypothesis blending in a bayesian framework

(76) Inventor: David Nister, Uppsala (SE)

Correspondence Address: ERICSSON INC., 6300 LEGACY DRIVE, M/S EVW2-C-2, PLANO, TX, 75024, US

(21) Appl. No.: 09/891,344

(22) Filed: Jun. 27, 2001

Related U.S. Application Data
(60) Provisional application No. 60/214,792, filed on Jun. 28, 2000.

(51) Int. Cl. G06K 9/00

(52) U.S. Cl. 382/154

(57) ABSTRACT

The present invention is directed toward a system and method for creation of an optimized depth map through iterative blending of a plurality of hypothetical depth maps in a Bayesian framework of probabilities. The system begins with an estimate of a depth map for a reference image, the estimated depth map becoming the current depth map. The system also has available to it a plurality of hypothetical depth maps of the reference image, derived from any of several known depth map generation methods and algorithms. The current depth map and each hypothetical depth map are compared iteratively, a pixel or pixel pair at a time, relying on minimizing reprojection and discontinuity energies through a graph cut process within a Bayesian probability framework to calculate the optimum assignment of depth map values to the reference image pixels. In this process, the two depth maps are blended into a depth map that is more representative of the reference image, with the blended depth map becoming the new, current depth map. The optimization or blending process terminates when the differences between depth map values for each pixel or each group of pixels reach a desired minimum.

### CROSS-REFERENCE TO RELATED APPLICATION

This application is based upon and claims priority from U.S. provisional application No. 60/214,792, filed Jun. 28, 2000, the contents being incorporated herein by reference.

### BACKGROUND OF THE INVENTION

1. Field of the Invention

The present invention relates generally to systems for estimating depth maps by matching calibrated images, and more particularly, to a system for progressive refining of depth map estimations by application of a Bayesian framework to the known reference image data and the probability of the depth map, given the reference image data.

2. Background Information

Computer-aided imagery is the process of rendering new two-dimension and three-dimension images of an object or a scene on a terminal screen or graphical user interface from two or more digitized two-dimension images with the assistance of the processing and data handling capabilities of a computer. Constructing a three-dimension (hereinafter “3D”) model from two-dimension (hereinafter “2D”) images is utilized, for example, in computer-aided design (hereinafter “CAD”), 3D teleshopping, and virtual reality systems, in which the goal of the processing is a graphical 3D model of an object or a scene that was originally represented only by a finite number of 2D images. Under this application of computer graphics or computer vision, the 2D images from which the 3D model is constructed represent views of the object or scene as perceived from different views or locations around the object or scene. The images are obtained either from multiple cameras positioned around the object or scene or from a single camera in motion around the object, recording pictures or a video stream of images of the object. The information in the 2D images is combined and contrasted to produce a composite, computer-based graphical 3D model. While recent advances in computer processing power and data-handling capability have improved computerized 3D modeling, these graphical 3D construction systems remain characterized by demands for heavy computer processing power, large data storage requirements, and long processing times. Furthermore, volumetric representations of space, such as a graphical 3D model, are not easily amenable to dynamic modification, such as combining the 3D model with a second 3D model or perceiving the space from a new view or center of projection.

Typically the construction of a 3D image from multiple views or camera locations first requires camera calibration for the images produced by the cameras to be properly combined to render a reasonable 3D reconstruction of the object or scene represented by the images. Calibration of a camera or a camera location is the process of obtaining or calculating camera parameters at each location or view from which the images are gathered, with the parameters including such information as camera focal length, viewing angle, pose, and orientation. If the calibration information is not readily available, a number of calibration algorithms are available to calculate the calibration information. Alternatively, if calibration information is lacking, some graphical reconstruction methods estimate the calibration of camera positions as the camera or view is moved from one location to another. However, calibration estimation inserts an additional variable in the 3D graphical model rendering process that can cause inaccuracies in the output graphics. Furthermore, calibration of the camera views necessarily requires prior knowledge of the camera movement and/or orientation, which limits the views or images that are available to construct the 3D model by extrapolating the calibrated views to a new location.

One current method of reconstructing a graphical 3D model of an object from multiple views is by using pairs of views of the object at a time in a process known as stereo mapping, in which a correspondence between the two views is computed to produce a composite image of the object. However, shape information recovered from only two views of an object is neither complete nor very accurate, so it is often necessary to incorporate images from additional views to refine the shape of the 3D model. Additionally, the shape of the stereo mapped 3D model is often manipulated in some graphical systems by the weighting, warping, and/or blending of one or more of the images to adjust for known or perceived inaccuracies in the image or calibration data. However, such manipulation is a manual process, which not only limits the automated computation of composite graphical images but also risks introducing errors as the appropriate level of weighting, warping, and/or blending is estimated.

Recently, graphical images in the form of depth maps have been applied to stereo mapping to render new 2D views and 3D models of objects and scenes. A depth map is a two-dimension array of values for mathematically representing a surface in space, where the rows and columns of the array correspond to the x and y location information of the surface; and the array elements are depth or distance readings to the surface from a given point or camera location. A depth map can be viewed as a grey scale image of an object, with the depth information replacing the intensity and color information, or pixels, at each point on the surface of the object. Accordingly, surface points are also referred to as pixels within the technology of 3D graphical construction, and the two terms will be used interchangeably within this disclosure.

A graphical representation of an object can be estimated by a depth map under stereo mapping, using a pair of calibrated views at a time. Stereo depth mapping typically compares sections of the two depth maps at a time, attempting to find a match between the sections so as to find common depth values for pixels in the two maps. However, since the estimated depth maps invariably contain errors, there is no guarantee that the maps will be consistent with each other and will match where they should. While an abundance of data may be advantageous to minimize the effect of a single piece of bad or erroneous data, the same principle does not apply to depth maps where any number of depth maps may contain errors because of improper calibration, incorrect weighting, or speculations regarding the value of the particular view, with any errors in the depth maps being projected into the final composite graphical product. Furthermore, conventional practices of stereo mapping with depth maps stop the refinement process at the estimation of a single depth map.

An alternate method of determining a refined estimate of a depth map of a reference image, or the desired image of an object or scene, is through the application of probabilities to produced a refined depth map from a given estimated depth map. In particular, an existing, estimated depth map and the known elements associated with a reference image are applied in a Bayesian framework to develop the most probable, or the maximum a posteriori (hereinafter termed “MAP”), solution for a refined estimated depth map which is hopefully more accurate than the original, estimated depth map.

The Bayesian framework presented below is representative of the parameters that are utilized to compute a refined, estimated depth map through the application of the Bayesian hypothetical probabilities that the result will be more accurate than the original, given the known input values. Here, the known values are include an estimated depth map of an image, the reference image information, and the calibration information for the image view. The probability of a depth map Z being accurate, given the reference image data D and the a priori information I (calibration information, camera pose, assumptions about the world state for the image, etc.), is represented as:

$$Pr ( Z \vert DI ) = \frac{Pr ( \tilde{D} \vert {Zd}_{1} I ) Pr ( Z \vert {d}_{1} I ) Pr ( {d}_{1} \vert I )}{Pr ( D \vert I )}$$

where d₁ represents the reference image and \tilde{D} represents the rest of the images. The maximum a posteriori solution is defined as:

Z_{MAP}=Pr(Z|DI)=max Pr(D|Zd₁I)Pr(Z|d₁I)

The term Pr(Z|d₁I) is the probability of the depth map Z given the reference image. The term Pr(\tilde{D}|Zd₁I) is the probability of the rest of the images, given the first image and its corresponding depth map. Solving the probability formula can be accomplished by viewing the formula as an energy equation and solving the energy equation to minimize the energy costs. The above formulation can be put in the energy domain as:

$${Z}_{MAP} = \begin{matrix}min \\ z\end{matrix} [ - ln Pr ( \tilde{D} \vert {Zd}_{1} I ) - ln Pr ( Z \vert {d}_{1} I ) ] = \begin{matrix}min \\ z\end{matrix} [ {E}_{\overline{D} \vert {Zd}_{1} I} + {E}_{Z \vert {d}_{1} I} ]$$

The respective logarithms of the inverted (negative) probabilities correspond to the energy terms, E_{\tilde{D}|Zd}_{₁}_{I} and E_{Z|d}_{₁}_{I}, where E_{\tilde{D}|Zd}_{₁}_{I} represents the measure of the reprojection error and E_{Z|d}_{₁}_{I} represents the measure of the discontinuity error of the hypothetical depth map. The reprojection error represents the sum of error contributions from each individual pixel. The advantage of converting the formula to logarithmic form is avoiding the very small numbers associated with the respective probabilities and the corresponding precision problems when multiplying such numbers within efficient computer processing.

The probability associated with the reprojection error is evaluated by examining the distribution of the reprojection components of each pixel in the hypothetical depth map. In particular, the frequency function of the reprojection components of each pixel is represented as a contaminated, three-dimensional Gaussian distribution:

$$f ( Y , U , V ) = \frac{{P}_{0}}{{256}^{3}} + \frac{( 1 - {P}_{0} )}{\sqrt{2 {π}^{3}} {σ}^{3}} {ⅇ}^{\frac{- ( {( Y - \overline{Y} )}^{2} + {( U - \overline{U} )}^{2} + {( V - \overline{V} )}^{ 2} )}{2 {σ}^{2}}}$$

which represents the distribution of three pixel reprojection values around an ideal distribution if the hypothetical depth map were a pure reproduction of the reference image. Y, U, V are the luminance and chrominance color components of the pixel, and Y, U, and V represent the respective ideal component values for the pixel, given the reference image. P₀ is the probability that the reprojected pixel is gravely different due to occlusion, specular reflection, calibration errors, etc. 256 represents the number of colors in the useful spectrum, and is raised to the third power because the distribution formula is evaluating three components of color, namely, Y, U, and V. e is the base of the natural logarithm, 2.81. σ represents the measure of the standard deviation around the norm for the reprojection components, with the pixels assigned a uniform distribution. Viewing the probabilities of the Gaussian distribution as an energy problem, the energy term E_{\tilde{D}|Zd}_{₁}_{I} can therefore be viewed as a sum of the pixel reprojection energies

Eᵣ=−1nf(Y,U,V)

over all pixels in the reference image.

The discontinuity energy, E_{Z|d}_{₁}_{I}, between the estimated depth map and the hypothetical depth map is comprised of an error contribution from every pair of four-connected pixel neighbors 100-106, in the image, as shown in FIG. 1. The probability of a discontinuity in each pixel's depth field is higher, given a corresponding discontinuity in the components of the reference image's pixel 100, such as luminance Y. This derives from the principle that adjacent or neighboring pixels tend to have similar features and characteristics. Any discontinuity in the luminance between pixel 100 and pixel 102 is represented by h 110, which can also be viewed as a horizontal bond between pixel 100 and pixel 102. The smaller the energy required to break this bond, the less the discontinuity between the pixels 100 and 102. Correspondingly, v 114 represents the vertical bond between pixel 100 and neighboring pixel 104. Any discontinuity between pixel 100 and 104, for example, can be modeled by smaller contributions to the discontinuity energy where the gradient ∇Y=[YₓY_{y}] is large, and where ₓ and _{y} represent the coordinates of the pixel 100. To accomplish this, two energy coefficients cₕ and cᵥ, corresponding to the horizontal 110 and vertical 114 bonds between adjacent pixels 100 and 104, are used. The energy of these bonds, as representing a gradient in a pixel component Y, is expressed as:

Eₕ=αcₕV(z₁,z₂)

Eᵥ=αcᵥV(z₁,z₂)

where α is a weight determined through experiments, z₁ and z₂ are the depth values for the adjacent pixels related to the bond, and a distance value V is a metric (as satisfying a triangle inequality). The energy coefficients are set to

$$\begin{matrix}{c}_{h} = f ( \vert ▽ Y \vert ) \frac{1}{2 \vert {Y}_{x} \vert} \\ {c}_{v} = f ( \vert ▽ Y \vert ) \frac{1}{2 \vert {Y}_{y} \vert}\end{matrix}$$

where f: [symbol] → [symbol] is a derived, suitable function. The basis for these relationships is that a discontinuity shaped as a straight line of length l, with a luminance gradient ∇Y perpendicular to the line, will cross approximately l|Yₓ∥∇Y|⁻¹ horizontal and l|Y_{y}∥∇Y|⁼¹ vertical bonds. The cost of such a discontinuity is therefore proportional to

l|∇Y|⁻¹(|Yₓ|cₕ+|Y_{y}|cᵥ)=l|∇Y|⁻¹f(|∇Y|)

and is thus independent of the orientation of the discontinuity. By representing the image quantity as a vector, made up of the luminance and the chrominance components, as:

w=[YUV]^{T},

the energy coefficients can be generalized to:

$$\begin{matrix}{c}_{h} = f ( ‖ J ‖ ) \frac{1}{2 \sqrt{{w}_{x}^{T} {w}_{x}}} \\ {c}_{v} = f ( ‖ J ‖ ) \frac{1}{2 \sqrt{{w}_{y}^{T} {w}_{y}}}\end{matrix}$$

where J=[wₓw_{y}] is the 3×2 Jacobian matrix derivative as the measure of degree of change of magnitude of color around the pixel with coordinates ₓ and _{y}. The matrix norm is ∥J∥=\sqrt{wₓ^{T}wₓ+w_{y}^{T}w_{y}}. The derived function f(x) determines how the energy of a discontinuity varies with |J|. Here, it is set to:

$$f ( x ) = x ( {a}_{min} + \frac{1}{{x}^{2}} ) ,$$

where the constant αₘᵢₙ establishes a minimum cost of a discontinuity. Further, the metric V can then be set to:

V(z₁,z₂)=min(1,T_{d}⁻¹u₁−1|u₂|),

where T_{d} is the threshold where the disparity is considered a discontinuity, and u₁ and u₂ are disparities in some view other than the first view as calculated from the depth map values. u₁ and u₂ are pixels along a back-projected ray in a certain, first view, with corresponding different depth values. These pixels will be viewed as a common point in this first view but would be viewed in another view as being separate points having a distance between them and as being separate pixels with some degree of discontinuity between them.

A recently devised method to search for the best depth map values, pixel by pixel, by solving the above energy functions is to use graph cuts. Then, in every iteration along a ray from a center of projection for the reference image, the depth map solution achieved so far is tested against a fixed depth value in a plane, such that the final solution may attain the fixed depth map value at any pixel of the image. All depth values of the reference image are then traversed until a optimum value is found. However, in a setting where the number of possible depth maps are many, and where the hypothetical depth map used bears little resemblance to the desired depth map, it is prohibitively slow to test all depth maps values with such a method; and convergence to a depth map with a predetermined degree of accuracy is not assured.

The preferred embodiments of the present invention overcome the problems associated with existing systems for deriving an optimized depth map of a reference image of an object or a scene from an estimated depth map and one or more hypothetical depth maps.

### SUMMARY OF THE INVENTION

The present invention is directed toward a system and method for creation of an optimized depth map through iterative blending of a plurality of hypothetical depth maps in a Bayesian framework of probabilities. The system begins with an estimate of a depth map for a reference image, the estimated depth map becoming the current depth map. The system also has available to it a plurality of hypothetical depth maps of the reference image, derived from any of several known depth map generation methods and algorithms. Each of the hypothetical depth maps represent a complex depth map that is a reasonable approximation of the reference image, given the reference, orientation, and calibration information available to the system. The current depth map and each hypothetical depth map are compared iteratively, one or two pixels at a time, relying on a Bayesian framework to compute the probability whether the hypothetical depth map, at the pixel in question, is a closer representation of the reference image than the current depth map. The depth map value that is found to have a higher probability of better representing the image is selected for the current depth map. In this process, the two depth maps are blended into a depth map that is more representative of the image, with the blended depth map becoming the new, current depth map. The probabilities are determined based on the goal of minimizing the discontinuity and reprojection energies in the resultant depth map. These energies are minimized through the process of comparing the possible depth map graph cut configurations between the two possible depth map value choices at each pixel. The optimization or blending process terminates when the differences between depth map values at each pixel or each group of pixels reach a desired minimum.

In accordance with one aspect of the present invention, a system and method are directed toward optimizing an estimate of a depth map of a reference image through the blending of a plurality of depth maps, taken two depth maps at a time, including calculating the reprojection energies of assigning each of two adjacent pixels of a reference image to each of two separate depth maps; calculating the discontinuity energies associated with each pixel of the adjacent pixels of the reference image and associated with the edge between the adjacent pixels of the reference image; and assigning depth map values for the two adjacent pixels based on a minimum graph cut between the two separate depth maps, given the adjacent pixels and the calculated reprojection and discontinuity energies.

In accordance with another aspect of the present invention, a system and method are directed toward estimating a depth map of a reference image through the blending of a plurality of depth maps, taken two depth maps at a time, including estimating a current depth map of a specific view of a reference image; and for each of a plurality of derived hypothetical depth maps of the reference image, performing the following: for each pixel on the current depth map that corresponds to a pixel on the hypothetical depth map, comparing the depth map value of the pixel on the current depth map with the depth map value of the pixel on the hypothetical depth map; and replacing the depth map value of the pixel on the current depth map with the corresponding depth map value of the pixel on the hypothetical depth map if the compared depth map value of the pixel on the hypothetical depth map has a higher probability of accurately representing the reference image than does the compared depth map value of the pixel on the current depth map.

In accordance with yet another aspect of the invention, a system and method are directed toward optimizing an estimate for a depth map of a reference image of an object, including estimating a first depth map of a desired view of a reference image of an object; and for each of a plurality of derived hypothetical depth maps of the reference image, performing the following: for every pixel within both the first depth map and the derived hypothetical depth map, applying a Bayesian probability framework to determine the optimum pixel between the two depth maps, wherein said determination is accomplished by minimizing the energy costs associated with graph cuts between neighboring pixel pairs; and replacing the depth map value in the first depth map with the optimum depth map value.

### BRIEF DESCRIPTION OF THE DRAWINGS

These and other objects and advantages of the present invention will become more apparent and more readily appreciated to those skilled in the art upon reading the following detailed description of the preferred embodiments, taken in conjunction with the accompanying drawings, wherein like reference numerals have been used to designate like elements, and wherein:

FIG. 1 shows the horizontal and vertical discontinuity energy bonds between neighboring pixels in a reference image;

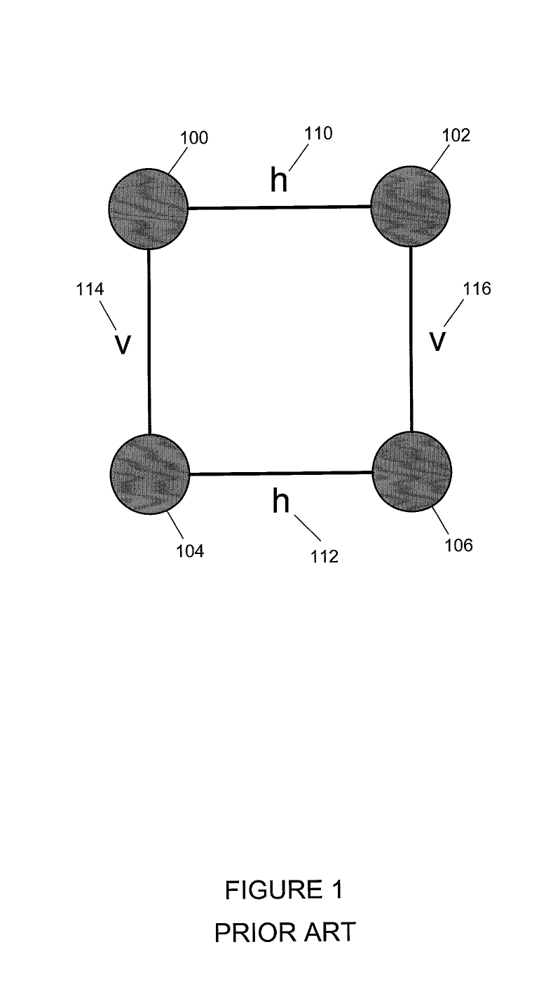

FIG. 2 shows a depth map section with adjacent pixel neighbors;

FIG. 3 is comprised of FIGS. 3a, 3b, 3c, and 3d, each of which show a different graph cut given discontinuities between two adjacent pixels;

FIG. 4 shows the edge weights associated with the discontinuity energies between a neighboring pixel pair; and

FIG. 5 illustrates the devices and communication links of an exemplary depth map optimization system.

### DETAILED DESCRIPTION OF THE PREFERRED EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

While the present invention can be utilized to derive optimized depth maps of reference images of virtually any object or scene, the discussion below will refer to all such images as being of “objects” to simplify the explanation of the embodiments of the invention. All embodiments of the present invention begin with an estimated depth map of a reference image of an object from a known view, or center of projection. The estimated depth map is derived from any one of a plurality of known methods for estimating or deriving depth maps. A second, hypothetical depth map of the image is derived, with the second depth map also being derived from any one of a plurality of known depth map derivation methods. The second depth map is preferably a complex, multi-plane depth map that reasonably mathematically approximates the reference image. While such an approximate depth map is not required for the present invention to derive an optimized depth map converging to a desired minimum discontinuity, the processing of the present invention will be minimized if such approximations are utilized. The combination, in the present invention, of a Bayesian probability framework with a complex hypothetical depth map derivation has the advantage of preserving depth discontinuities that can naturally exist within a reference image while still exploiting spatial coherence of depth map values.

Preferred embodiments of the present invention utilize graph cuts for reference image pixel pairs to minimize the reprojection and discontinuity energies of the Bayesian framework to blend two depth maps at a time into one consistent depth map with a high a posteriori probability. The process, given an estimate of the entire depth map, denoted f(x), and an additional hypothetical depth map, denoted g(x), over at least a subregion of the reference image, iteratively blends the optimum depth map values into the estimated depth map f(x). The blended solution is the maximum a posteriori solution over the set of hypothetical depth maps that for any pixel location xᵢ in the reference image predicts either the depth map value j(xᵢ) or the depth map value g(xᵢ) as the better depth map value for representing the corresponding reference image pixel.

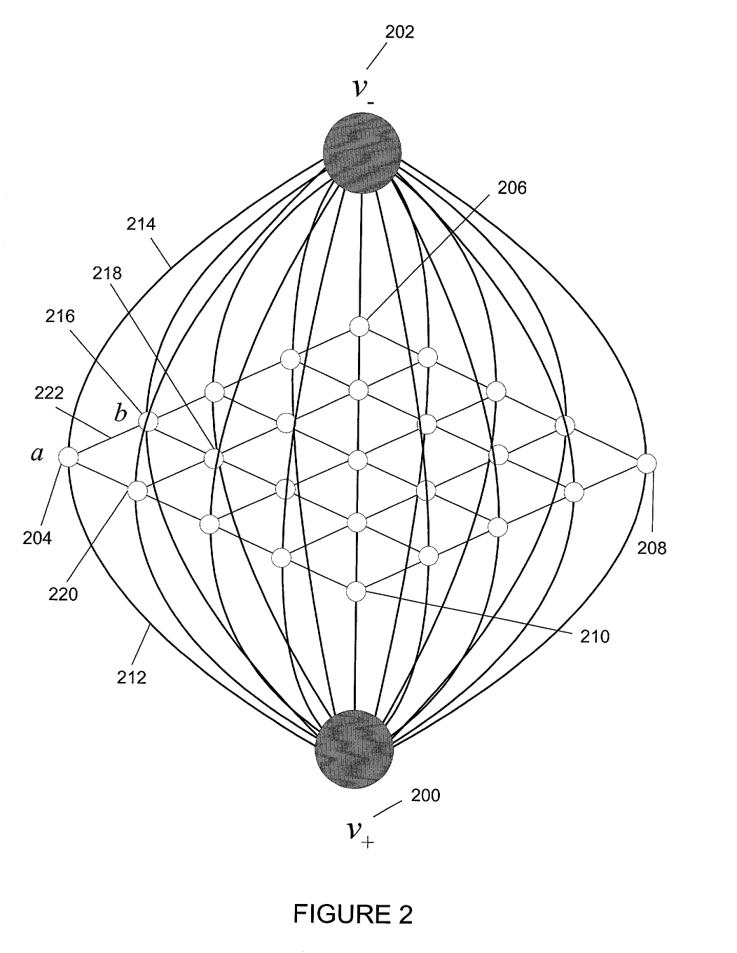

Referring now to FIG. 2, there is shown, for example, a reference image segment comprised of twenty-five pixels and characterized by the pixel vertices 204, 206, 208, and 210. The source, v₊ 200, represents the hypothetical, derived depth map g(x), and the sink, v₋ 202, represents the estimated depth map f(x). The determination of the more probable depth map value, pixel by pixel, between the depth maps f(x) and g(x) is accomplished through the energy minimization process by seeking the minimum graph cut C on a graph G=<V, E>, where the set of vertices V={x}_{i=J}^{N×M}∪{v₊}∪{v₋} is the set of pixels shown in FIG. 2 plus the source, v₊ 200, and the sink, v₋ 202. The graph cut C acts to separate the source v₊ 200 from the sink v₋ 202 by determining an assignment of pixels to, alternatively, the sink v₋ 202 or the source v₊ 200 and, thereby, allocating to each pixel of the reference image the depth map value of either f(xᵢ) or g(xᵢ), respectively. The minimum graph cut C is that cut through the graph represented by the pixels of FIG. 2 such that the sum of the cut, or broken, edge weights is minimized, as discussed more thoroughly below.

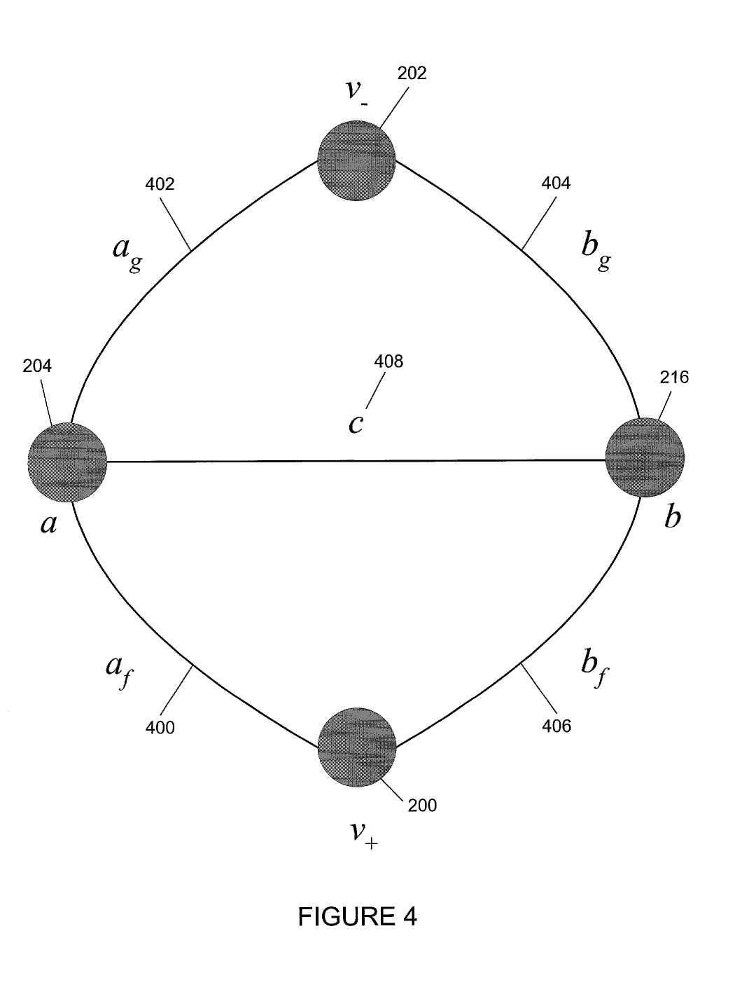

Each pixel, such as pixel a 204, is connected with an edge to the source v₊ 200 (edge 212), an edge to the sink v₋ 202 (edge 214), and at least one edge, such as edge 222, to at least one neighboring pixel b 216. Each of these edges has an energy, or weight, which represents a measure of discontinuity between the two pixels. The edge weights of the graph are defined such that if pixel xᵢ is connected to sink v₋ 202 in the cut graph, G′=<V,E∩\overline{C}>), then the depth map value f(xᵢ) is associated with pixel xᵢ or, otherwise, the depth map value g(xᵢ) is associated with pixel xᵢ. Referring briefly to FIG. 4, the energies associated with assigning each pixel of an adjacent, or neighboring, pixel pair a 204 and b 216 to the depth map f(x) or g(x) is shown. For example, the edge weight, or the energy cost, associated with assigning pixel a 204 to depth map f(x) is shown as a_{g} 402 because the bond between pixel a 204 and sink v₋ represents the energy required to break the edge or link between pixel a 204 and the source v₊ 200, which is associated with depth map g(x).

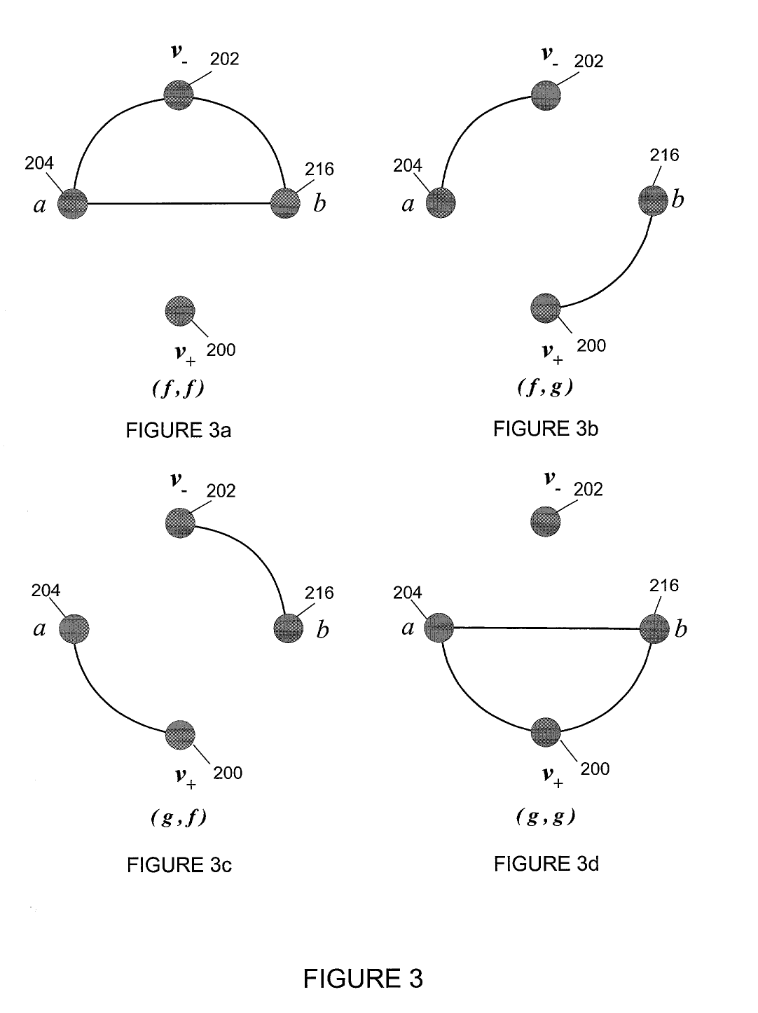

Referring now to FIGS. 2 and 3, the cut graph for a pair of neighboring pixels a 204 and b 216 has four possible configurations, corresponding to the hypothetical assignments (f,f), (f,g), (g,f) and (g,g), respectively shown in FIGS. 3a, 3b, 3c, and 3d. FIG. 3 a represents the assignment of both pixels a 204 and b 216 to the estimated depth map f(x) at the sink v₋ 202. This assignment is graphically shown in FIG. 3a with the breaking of the edges or bonds between pixels a 204 and b 216 and the source v₊ 200. FIG. 3b shows the assignment of pixel a 204 to the sink v₋ 202 and depth map f(x) and the assignment of pixel b 216 to the source v₊ 200. Therefore, the assignment of depth values represented by FIG. 3b denotes pixel a 204 of the reference image being assigned the corresponding depth map value from the estimated depth map f(x), and pixel b 216 of the reference image being assigned the corresponding depth map value from the hypothetical depth map g(x). Similarly, FIG. 3c shows the assignment of pixel a 204 to the source v₊ 200 and pixel b 216 to the sink v₋ 202; and FIG. 3d shows the assignment of both pixels a 204 and b 216 to the source v₊ 200.

Determining which one of the four possible assignments is the optimum assignment for each pixel pair is based on minimizing the energy costs associated with each assignment, said assignment necessarily requiring several individual energy costs associated with the breaking of the edges or bonds broken by the assignments. The objective is to have the sum of the costs of the removed edges equal the energy associated with the assignment plus possibly a constant for all of these configurations. This is possible provided that the discontinuity energy E_{d} for each of the four configurations satisfy the inequality E_{d}(f,f)+E_{d}(g,g)≦E_{d}(f,g)+E_{d}(g,f). Here, E_{d}(f_{g}) is represented by FIG. 3b and denotes the discontinuity energy associated with assigning the first pixel of the pixel pair to f(x) and the second pixel to g(x) and, specifically, is the sum of the costs of breaking the bond between pixel a 204 and the source v₊ 200 and breaking the bond between pixel b 216 and the sink v₋ 202. Note also that the assignments represented by FIGS. 3b and 3c have the additional cost of breaking the edge between pixels a 204 and b 216. Additionally, the discontinuity energy Ed satisfies the triangle inequality requirement for qualifying as a metric. Furthermore, the depth map g(x) is assumed to be continuous, which means that approximately E_{d}(g,g)≈0, and the requisite inequality is at least approximately satisfied. Referring now to FIG. 4, to compute the weights of the edges between the pixels and the source v₊ 200, the sink v₋ 202, and each other (represented as c 408 in FIG. 4), the inventive system begins with calculating the weight, or energy, of the edge from pixel a 204 to source v₊ 200 (edge 212) as the reprojection energy Eᵣ of assigning a 204 to source f(x), designated as a_{f} 400. The same is done regarding the edge from pixel b 216 to the source v₊ 200, designated as b_{f} 406. Similarly, for pixels a and b, the weights of the respective edges from a 204 and b 216 to the sink v₋ 202 are set to the reprojection energies of assigning a 204 and b 216 to g(x), designated respectively as a_{g} 402 and b_{g} 404.

The discontinuity energy for all neighboring pairs of pixel vertices a 204 and b 216 is calculated as follows. As discussed above, the weights of the edges from the first and second pixels, a 204 and b 216, to v₊ 200 will be denoted by a_{f} 400 and b_{f} 406, respectively. Similarly, the weights of the edges from the first and second pixels, a 204 and b 216, to v₋ 202 are denoted by a_{g} 402 and b_{g} 404, respectively. Finally, the weight of the edge between the first and second pixels, a 204 and b 216, is denoted by c 408.

Calculate the three discontinuity energy values:

m₁=[E_{d}(f,g)+E_{d}(g,f)−(E_{d}(f,f)+E_{d}(g,g))]/2

m₂=[E_{d}(f,f)+E_{d}(f,g)−(E_{d}(g,g)+E_{d}(g,f))]/2

m₃=[E_{d}(f,f)+E_{d}(g,g)−(E_{d}(g,g)+E_{d}(f,g))]/2

Adjust the reprojection energies with the calculated discontinuity energies as follows: Factor in the calculated discontinuity energy value to the edge between the pixel pair:

Add m₁ to c.

Factor in the calculated discontinuity energy value to the reprojection energy associated with pixel a 204:

If m₂>0, then

add m₂ to a_{f}.

else add −m₂ to a_{g}.

Factor in the calculated discontinuity energy value to the reprojection energy associated with pixel b 216:

If m₃>0, then

add m₃ to b_{f}.

else add −m₃ to b_{g}.

Determine the sum of the energy costs associated with each of the four possible assignments as respectively represented by FIGS. 3a, 3b, 3c, and 3d:

Eₐ=a_{g}+b_{g}.

E_{b}=a_{g}+b_{f}+c.

E_{c}=a_{f}+b_{g}+c.

E_{d}=a_{f}+b_{f}.

The configuration giving the smallest energy value of Eₐ−E_{d} represents the minimum cut of the graph and thereby the optimum assignment of the pixels a 204 and b 216 to the depth maps f(x) and g(x). This process is iterated over every pair of neighboring pairs in the reference image, blending the two depth maps f(x) and g(x) into an optimized depth map f(x); and can be repeated until no more changes (or minimal changes) of depth map association occurs during a full iteration over all pixel pairs. The result is a local minimum of the total energy corresponding to an optimal blending of the two depth maps f(x) and g(x) into one depth map. Once all pixel pairs have been processed through the above graph cut minimization process, a new hypothetical depth map g(x) can be derived from any one of a number of known depth map derivation methods, and the optimization process continues with the existing, now partially optimized depth map f(x). In a preferred embodiment of the invention, the derived, hypothetical depth map is a complex, non-planar depth map that reasonably approximates the reference image in an attempt to speed the convergence to an optimum depth map. Each hypothetical depth map processed can be viewed as a single iteration in the inventive optimization process. As the optimization process proceeds, the relative variance between depth map values for each pixel or each group of pixels can be calculated and stored. Once the variance(s) has reached a predetermined minimum value of change, the optimization process can stop with convergence to an optimized depth map being accomplished in a finite number of steps. The resultant, optimized depth map f(x) is then stored and/or output for use as an optimized depth map representation of the reference image in any number of computer graphics and computer vision applications.

As briefly discussed above, in an alternate embodiment of the present invention, the optimization process of blending the two depth maps, a pixel pair at a time, can iterate multiple times across the pixels of the reference image. In this form of the invention, a new hypothetical depth map is not derived once all the reference image pixels are processed once. Instead, the set of reference image pixels are processed, a pixel pair at a time, multiple times as an additional level of iteration until the degree of improvement of the blended depth map reaches a predetermined minimum value, at which time a new, hypothetical depth map is derived; and the process is restarted, with the blended depth map becoming the estimated depth map.

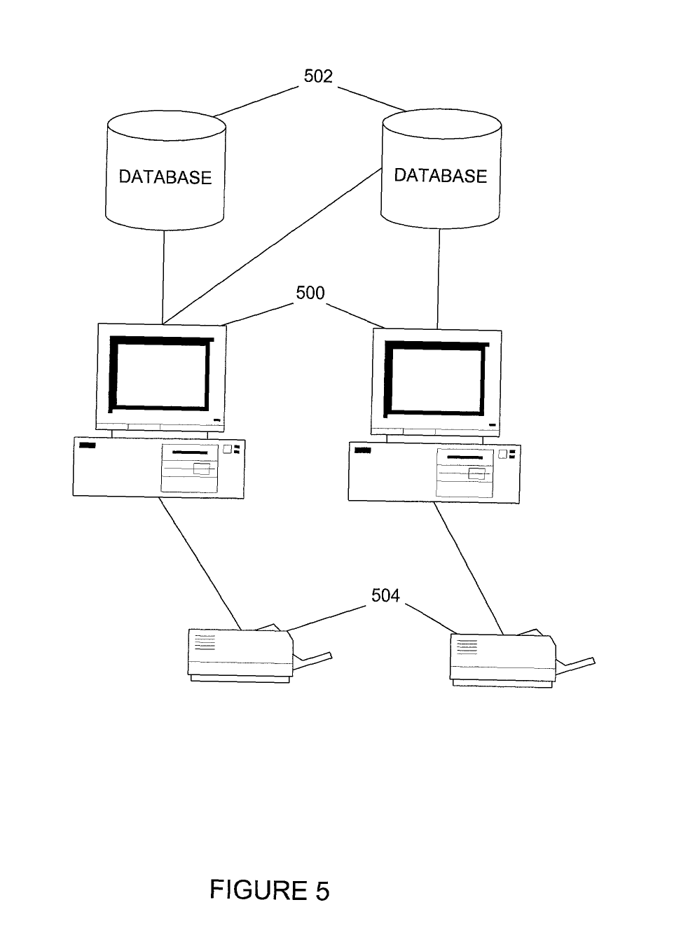

Referring now to FIG. 5, there are illustrated the devices and communication links of an exemplary depth map optimization system in accordance with the present invention. The components of FIG. 5 are intended to be exemplary rather than limiting regarding the devices and data or communication pathways that can be utilized in the present inventive system. The processor 500 represents one or more computers on which the present inventive system and method can operate to iteratively blend two depth maps into an optimum depth map. The various functional aspects of the present invention and the corresponding apparatus portions of the system for computing optimized depth maps, such as first, second, third, fourth, and fifth processors; comparison devices, and replacement devices, can reside in a single processor 500 or can be distributed across a plurality of processors 500 and storage devices 502.

Once the optimized depth map is computed by processor 500 and stored on a database 502, it can be accessed by any number of authorized users operating processors 500. These users can display a 2D representation of the optimized depth map on the screen or graphical user interface of the processor 500 and/or can print the same on a printer 504.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A method for optimizing an estimate of a depth map of a reference image through the blending of a plurality of depth maps, taken two depth maps at a time, comprising:
calculating the reprojection energies of assigning each of two adjacent pixels of a reference image to each of two separate depth maps;
calculating the discontinuity energies associated with each pixel of the adjacent pixels of the reference image and associated with the edge between the adjacent pixels of the reference image; and
assigning depth map values for the two adjacent pixels based on a minimum graph cut between the two separate depth maps, given the adjacent pixels and the calculated reprojection and discontinuity energies.

2. The method according to claim 1, wherein the step of assigning depth map values further includes:
adjusting the calculated reprojection energies with the calculated discontinuity energies;
determining the energy costs associated with assigning the two separate depth maps to the adjacent pixels; and
assigning depth map values for the two adjacent pixels based on the minimum energy cost associated with assigning the two separate depth maps to the adjacent pixels.

3. The method according to claim 1, wherein the two separate depth maps consist of a first, estimated depth map and a second, hypothetical depth map and wherein the step of assigning depth map values includes replacing depth map values of the first, estimated depth map to produce a third, optimized depth map which then becomes the first, estimated depth map for subsequent optimization iterations.

4. The method according to claim 3, wherein the second, hypothetical depth map is a complex, non-planar depth map.

5. The method according to claim 3, wherein the two adjacent pixels constitute a neighboring pixel pair.

6. The method according to claim 5, further including repeating the steps of calculating the reprojection energies, calculating the discontinuity energies, and assigning depth map values for each pixel pair of the reference image until the difference between the depth map values assigned at each iteration of the reference image pixel pair set reaches a predetermined minimum.

7. The method according to claim 6, further including deriving a new second, hypothetical depth map for further processing when the difference between the depth map values assigned at each iteration of a reference image pixel pair set reaches a predetermined minimum.

8. A method for estimating a depth map of a reference image through the blending of a plurality of depth maps, taken two depth maps at a time, comprising:
estimating a current depth map of a specific view of a reference image; and
for each of a plurality of derived hypothetical depth maps of the reference image, performing the following:
for each pixel on the current depth map that corresponds to a pixel on the hypothetical depth map, comparing the depth map value of the pixel on the current depth map with the depth map value of the pixel on the hypothetical depth map; and
replacing the depth map value of the pixel on the current depth map with the corresponding depth map value of the pixel on the hypothetical depth map if the compared depth map value of the pixel on the hypothetical depth map has a higher probability of accurately representing the reference image than does the compared depth map value of the pixel on the current depth map.

9. The method according to claim 8, wherein the view each of the plurality of hypothetical depth maps includes at least a subregion of the view of the current depth map.

10. The method according to claim 8, wherein one or more of the plurality of hypothetical depth maps is a complex, non-planar depth map.

11. The method according to claim 8, wherein the comparing of depth map values is terminated once the difference between the depth map values of the current depth map and the depth map values of the derived hypothetical depth map reaches a predetermined minimum.

12. The method according to claim 8, wherein the comparing of depth map values is performed a plurality of times across all pixels of the reference image until the difference between the depth map values of the current depth map and the depth map values of the derived hypothetical depth map reaches a predetermined minimum.

13. The method according to claim 8, wherein the probability of accurately representing the reference image is determined according to a Bayesian framework.

14. The method according to claim 13, wherein the probability of accurately representing the reference image is determined according to energy costs and graph cuts.

15. A method for optimizing an estimate for a depth map of a reference image of an object, comprising:
estimating a first depth map of a desired view of a reference image of an object; and
for each of a plurality of derived hypothetical depth maps of the reference image, performing the following:
for every pixel within both the first depth map and the derived hypothetical depth map, applying a Bayesian probability framework to determine the optimum depth map value between the two depth maps, wherein said determination is accomplished by minimizing the energy costs associated with graph cuts between neighboring pixel pairs; and
replacing the depth map value in the first depth map with the optimum depth map value.

16. A system for optimizing an estimate of a depth map of a reference image through the blending of a plurality of depth maps, taken two depth maps at a time, comprising:
a first processor calculating the reprojection energies of assigning each of two adjacent pixels of a reference image to each of two separate depth maps;
a second processor calculating the discontinuity energies associated with each pixel of the adjacent pixels of the reference image and associated with the edge between the adjacent pixels of the reference image; and
a third processor assigning depth map values for the two adjacent pixels based on a minimum graph cut between the two separate depth maps, given the adjacent pixels and the calculated reprojection and discontinuity energies.

17. The system according to claim 16, wherein the third processor further includes:
a fourth processor adjusting the calculated reprojection energies with the calculated discontinuity energies;
a fifth processor determining the energy costs associated with assigning the two separate depth maps to the adjacent pixels; and
a replacement device assigning depth map values for the two adjacent pixels based on the minimum energy cost associated with assigning the two separate depth maps to the adjacent pixels.

18. A system for estimating a depth map of a reference image through the blending of a plurality of depth maps, taken two depth maps at a time, comprising:
a first processor estimating a current depth map of a specific view of a reference image; and
a second processor comprising the following for each of a plurality of derived hypothetical depth maps of the reference image:
a third processor comprising the following for each pixel on the current depth map that corresponds to a pixel on the hypothetical depth map:
a comparison device comparing the depth map value of the pixel on the current depth map with the depth map value of the pixel on the hypothetical depth map; and
a replacement device replacing the depth map value of the pixel on the current depth map with the corresponding depth map value of the pixel on the hypothetical depth map if the compared depth map value of the pixel on the hypothetical depth map has a higher probability of accurately representing the reference image than does the compared depth map value of the pixel on the current depth map.

19. The system according to claim 18, wherein the comparison device terminates processing once the difference between the depth map values of the current depth map and the depth map values of the derived hypothetical depth map reaches a predetermined minimum.

20. The system according to claim 18, wherein the comparison device compares the depth map values a plurality of times across all pixels of the reference image until the difference between the depth map values of the current depth map and the depth map values of the derived hypothetical depth map reaches a predetermined minimum.

21. The system according to claim 18, wherein the probability of accurately representing the reference image is determined according to a Bayesian framework.

22. The system according to claim 21, wherein the probability of accurately representing the reference image is determined according to energy costs and graph cuts.

23. A system for optimizing an estimate for a depth map of a reference image of an object, comprising:
a first processor estimating a first depth map of a desired view of a reference image of an object; and
a second processor comprising the following for each of a plurality of derived hypothetical depth maps of the reference image:
a third processor applying a Bayesian probability framework to determine the optimum depth map value between the two depth maps for every pixel within both the first depth map and the derived hypothetical depth map, wherein said determination is accomplished by minimizing the energy costs associated with graph cuts between neighboring pixel pairs; and
a replacement device replacing the depth map value in the first depth map with the optimum depth map value.
